(19) United States
(12) Patent Application Publication
(10) Pub. No.: US 2017/0020340 A1
(43) Pub. Date: Jan. 26, 2017

(54) MODULAR DEVICE FOR INTRODUCING EDIBLE FLUID TO FOOD PRODUCT

(71) Applicant: Mark W. Hockman, Park City, UT (US)

(72) Inventor: Mark W. Hockman, Park City, UT (US)

(21) Appl. No.: 15/151,979

(22) Filed: May 11, 2016

Related U.S. Application Data
(60) Provisional application No. 62/159,701, filed on May 11, 2015.

(51) Int. Cl. A47J 43/16; A23G 3/34; A23L 13/70

(52) U.S. Cl. CPC A47J 43/16; A23L 13/72; A23G 3/0063; A23V 2002/00

(57) ABSTRACT

A modular device for introducing an edible fluid to a food product includes a dispenser body having a cartridge receiving cavity associated therewith. A dispenser base is coupled or coupleable to the dispenser body, and a dispenser tip is coupled or coupleable to the dispenser base and is in fluid communication with the cartridge receiving cavity when in place. An actuatable piston is operably coupled to the dispenser body in communication with the cartridge receiving cavity. An insertable and removable cartridge is carriable by the dispenser body in the cartridge receiving cavity, and is positionable so as to be in communication with the actuatable piston. An edible fluid is carried by the cartridge, the edible fluid being dispensable to a food product through the dispenser tip when in place as the actuatable piston is actuated to cause the edible fluid to be expelled from the cartridge through the dispensing tip.

The present application claims the benefit of U.S. Provisional Patent Application No. 62/159,701, filed on May 11, 2015, the entirety of which is incorporated herein by reference.

### BACKGROUND

The process of tenderizing or basting meat has been performed for many years to improve the taste and/or tenderness of meat products prior to consuming them. In classic examples, meats are basted by applying fluids to the surface, or a hand tool such as a mallet or hammer is used which includes a series of teeth that are used to strike a meat product to thereby create openings in the meat. Sometimes, these openings are used to introduce an edible fluid, such as a marinade, to allow the marinade to permeate the meat. The marinade typically serves to further soften the meat and also to introduce flavorings into the meat. While such rudimentary basting and tenderizing devices have been used with some success, they do not offer food preparers a variety of options for marinating the meat, short of simply soaking the meat in a marinade after tenderization. Additionally, other rudimentary devices are also used to introduce edible fluids to food products, such as icing bags and tips, condiment dispensers, and the like.

### BRIEF DESCRIPTION OF THE DRAWINGS

The following drawings illustrate exemplary embodiments for carrying out the aspects of the present disclosure. Like reference numerals refer to like parts in different views or embodiments of the present technology in the drawings.

FIG. 1 is a front view of a modular device in accordance with an embodiment of the present disclosure;

FIG. 2 is a partially sectioned, exploded side view of some of the components of the modular device of FIG. 1;

FIG. 3 is a front, partially sectioned view of a cartridge in accordance with an aspect of the present disclosure;

FIG. 4 is a partially sectioned top view of a cap of the modular device of FIG. 1;

FIG. 5 is bottom view of a dispenser base in accordance with an embodiment of the present disclosure;

FIG. 6 is a side view of another dispenser base having multiple roller-type dispensing tips in accordance with an embodiment of the present disclosure;

FIG. 7A is a side view of a dispenser base and a dispensing tip in accordance with another aspect of the present disclosure;

FIG. 7B is a side view of a dispensing tip for use with the dispenser base of FIG. 7A;

FIG. 7C is a side view of another dispensing tip for use with the dispenser base of FIG. 7A;

FIG. 8 is a side cross-sectional view of an alternative modular device in accordance with an embodiment of the present disclosure;

FIG. 9A is a perspective view of a modular dispensing base and two different dispensing tips that are suitable for application of frosting in accordance with an embodiment of the present disclosure;

FIG. 9B is a perspective view of an integrated dispensing base with dispensing tip injectors that are suitable for injection of edible fluid into a meat product in accordance with an embodiment of the present disclosure;

FIG. 9C is a perspective view of a modular dispensing base and a dispensing tip basting brush suitable for basting a food product with an edible fluid in accordance with an embodiment of the present disclosure; and

FIG. 9D is a perspective view of a modular dispensing base and a dispensing tip roller suitable for tenderizing a meat product with an edible fluid in accordance with an embodiment of the present disclosure.

### DETAILED DESCRIPTION

Reference will now be made to the exemplary embodiments illustrated in the drawings, and specific language will be used herein to describe the same. It will nevertheless be understood that no limitation of the scope of the present disclosure is thereby intended. Alterations and further modifications of the inventive features illustrated herein, and additional applications of the principles of the present disclosure as illustrated herein, which would occur to one skilled in the relevant art and having possession of this disclosure, are to be considered within the scope of the present technology.

As used herein, the singular forms “a” and “the” can include plural referents unless the context clearly dictates otherwise. Thus, for example, reference to “a dispensing tip” can include one or more of such tips, if the context so dictates.

As used herein, the term “substantially” refers to the complete or nearly complete extent or degree of an action, characteristic, property, state, structure, item, or result. As an arbitrary example, an object that is “substantially” enclosed is an article that is either completely enclosed or nearly completely enclosed. The exact allowable degree of deviation from absolute completeness may in some cases depend upon the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As another arbitrary example, a composition that is “substantially free of” an ingredient or element may still actually contain such item so long as there is no measurable effect as a result thereof.

As used herein, the term “about” is used to provide flexibility to a numerical range endpoint by providing that a given value may be “a little above” or “a little below” the endpoint.

As used herein, the term “edible fluid” refers to a (generally) liquid substance that is fit for human consumption. Examples of such edible fluids include, without limitation, marinades, seasonings, juices, beverages, sauces, frostings, condiments, creams, etc. Such fluids can include solubilized fluids and/or solids dispersed as part of a liquid suspension. Viscosities ranging from water-like to highly viscous, but still flowable, are all considered fluids. The term “edible fluid” explicitly excludes fluids that are harmful for human consumption.

Relative directional terms are sometimes used herein to describe and claim various components of the systems of the present technology. Such terms include, without limitation, “upward,” “downward,” “horizontal,” “vertical,” etc. These terms are generally not intended to be limiting, but are used to most clearly describe and claim the various features of the present disclosure. Where such terms must carry some limitation, they are intended to be limited to usage commonly known and understood by those of ordinary skill in the art.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

In accordance with one aspect of the present disclosure, a modular device for introducing an edible fluid into or onto a food product is provided, including a dispenser body having a cartridge receiving cavity associated therewith. A dispenser base can be coupled or coupleable to the dispenser body, and a dispenser tip can be coupled or coupleable to the dispenser base and can be in fluid communication with the cartridge receiving cavity when in place. The dispenser tip can be a single dispenser tip, or a plurality of dispenser tips. Various dispenser tips can be used, which can be interchangeable, depending on the application. An actuatable piston can be operably coupled to the dispenser body in communication with the cartridge receiving cavity. An insertable and removable cartridge can be carriable by the dispenser body in the cartridge receiving cavity, the cartridge being positionable so as to be in communication with the actuatable piston. An edible fluid can be carried by the cartridge, the edible fluid being injectable into or deliverable onto a food product through the dispenser tip(s) as the actuatable piston is actuated to cause the edible fluid to be expelled from the cartridge through the dispensing tip(s). In one specific example, a cap can be removably coupled to the dispenser body, the cap being removable to allow the cartridge to be installed within or withdrawn from the cartridge receiving cavity. In another example, the cartridge can be inserted and removed when the dispenser body is removed. In still another example, the cartridge can be inserted and removed through as side opening, which can also be a viewing window or opening.

In accordance with another aspect of the disclosure, a method of applying an edible fluid to a food product utilizing a modular device that includes a series of dispenser tips adapted for interchangeability and a dispenser body adapted for receiving insertable and removable cartridges is disclosed. The method can include steps of selecting a dispenser tip suitable for delivering an edible fluid to the food product, positioning a cartridge within a dispenser body, the cartridge carrying the edible fluid, attaching the dispenser tip to the dispenser body and in fluid communication with the edible fluid within the cartridge, and manually actuating a piston associated with the dispenser body to impel the edible fluid from the cartridge through the dispensing tip and into or onto the food product. In some examples, steps can include removing the cartridge and replacing it with a second cartridge. In further detail, in some examples, actuating the piston causes a moveable seal within the cartridge to impel movement of the edible fluid from the cartridge. In other examples, the cartridge can have a seal that is manually removed prior to insertion into the dispenser body.

Thus, the present technology relates generally to systems and methods used in preparing food items. The modular devices of the present technology can be used to inject or otherwise apply an edible fluid or liquid, such as a seasoning, marinade, sauce, condiments, frosting/icing, etc., into or onto food products. In one specific example, due to the unique design, the modular device can both inject and/or baste meat products with the edible fluid while at the same time tenderizing the meat product. Tenderization is achieved with one or more dispensing tips that can both pierce the surface of a meat product and inject the edible fluid into the meat product. In some embodiments, the modular device can be used to apply an edible fluid to the surface of a food product. In such case, the dispensing tip(s) does not necessarily pierce the surface of the food product, but merely dispenses the fluid onto the surface. This aspect can be advantageous, for example, in basting applications with meats or with frosting techniques with desserts. For example, because of the modular aspects of the device, dispensing tips suitable for applying frostings, icings, or cake/pastry decoration fluids can also be used with these devices.

It is noted that there will be much discussion herein regarding a particular embodiment related to injecting edible fluids into meats. That being stated, this is for exemplary purposes only, as other types of dispenser tips and other types of food products can be used. For example, an injector tip for use with meats may be replaced with a frosting tip for decorating gingerbread houses or cakes, or a basting tip for turkey basting. Thus, discussion of the device in one context, i.e. meat injection, can be applicable to other embodiments, i.e. dessert decorating, basting, or tenderizing, by simply replacing the dispenser tip and replacing the cartridge with an edible fluid suitable for that particular application. Additionally, discussion of a “modular injector” herein is sometimes discussed more generally as a “modular device” and vice versa. These terms can be used interchangeable with the understanding that when a dispenser tip is present that is suitable for edible fluid injection into a meat product, it can be referred to more specifically as a modular injector. In other words, a modular injector is a more specific embodiment of a modular device where the dispenser tip includes an injector.

The types of food products with which the technology can be used vary widely. Many meat products, such as chicken, roasts, steaks, etc., can be tenderized and injected with a marinade, for example, prior to being cooked. Other dishes that benefit from the application of a liquid to a surface of a food product can also be prepared using the present technology. Baked goods (pastries) can be frosted with frosting (which includes icings, cream cheese, or the like), or can be otherwise treated with a fluid on the surface of the goods. Essentially any food product to which a liquid or fluid is desired to be added (or injected) can be utilized with the present technology. While no food products are shown in detail in the figures, one of ordinary skill in the art having possession of this disclosure will readily appreciate how to utilize the present systems with such food products.

The present technology provides these various aspects with a modular system that allows the use of interchangeable cartridges of fluid, and interchangeable dispensing tips. For example, when preparing a particular meal, it may be desired to first inject a first edible liquid into a food product, then change to a cartridge containing another edible liquid and inject this further liquid. Also, the system can easily be adapted to first inject food products with a liquid, after which the modular device can be used to apply another liquid to only a surface of that or another food product. Changing of the fluid cartridge and the dispensing tips can be accomplished very quickly and with minimal expertise.

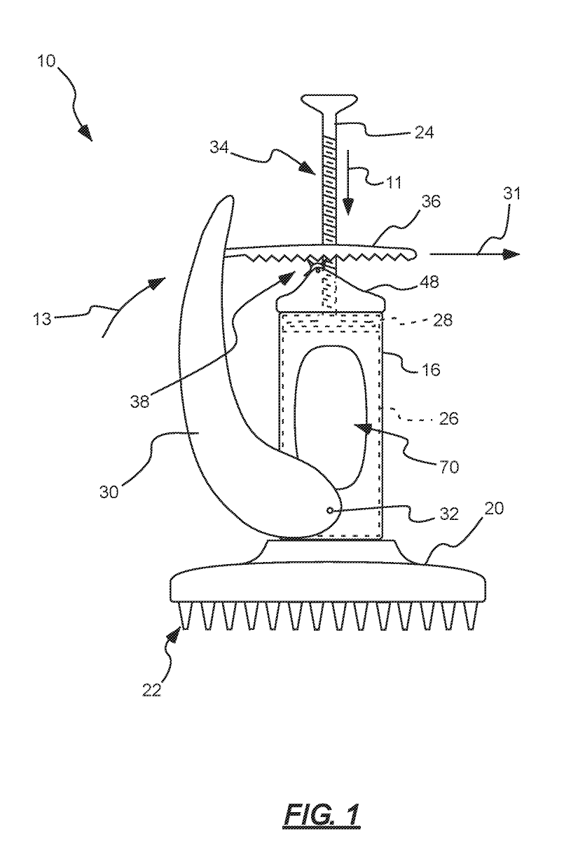

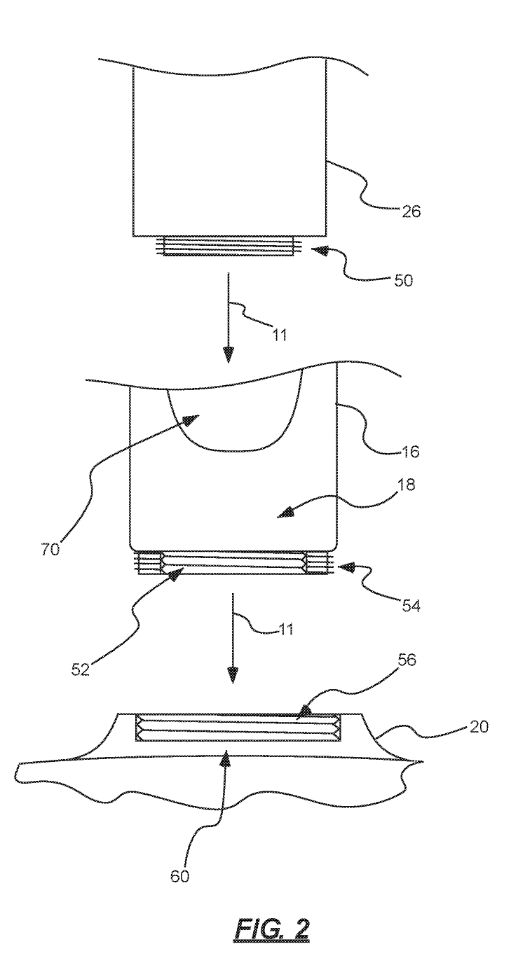

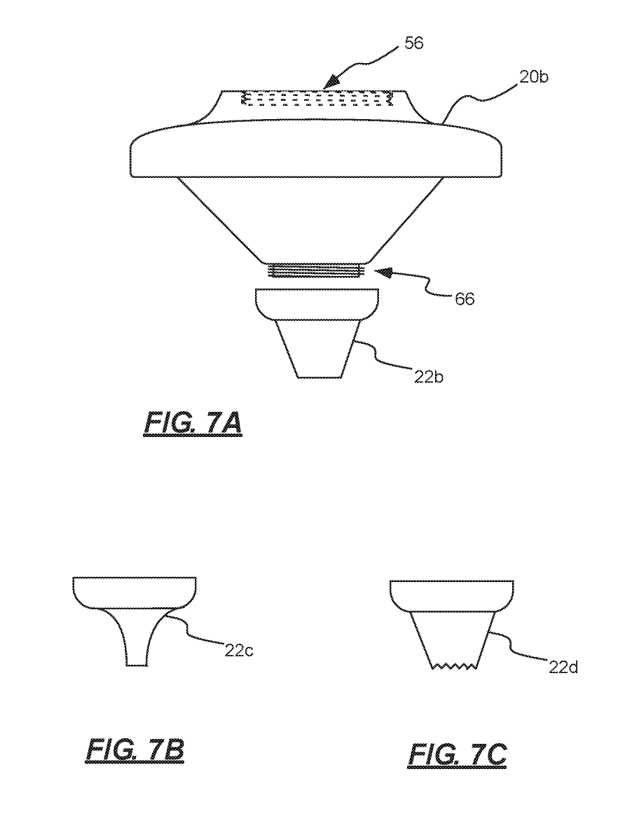

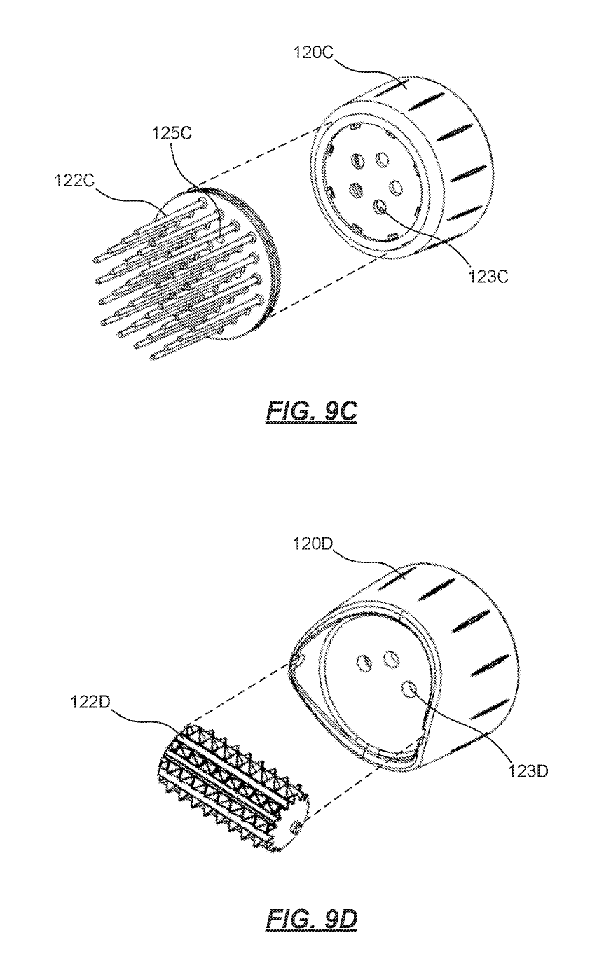

Turning now to the various figures, primarily FIG. 1, it can be seen that the technology provides an injector 10 for introducing an edible fluid (14 in FIG. 3) into a food product (not shown in detail). The modular injector can include a dispenser body 16 that can define or have attached thereto a cartridge receiving cavity (18 in FIG. 2). A dispenser base 20 (which can also be called a dispenser adaptor) can be coupled to the dispenser body. The dispenser base can carry, or can have attached thereto, a series of dispenser tips 22. These dispenser tips are in fluid communication with the cartridge receiving cavity, as described in more detail below. The dispenser base and the dispenser tips can be a single integrated unit, or be part of a modular assembly. A specific example of an integrated unit where the dispenser base is integrated with dispenser tips can be seen in FIGS. 1, 6 and FIG. 9B, whereas a modular assembly of a dispenser base and tips can be seen in FIGS. 7A-7C and FIGS. 9A, 9C, and 9D.

The injector 10 can include an actuatable piston 24 that can be operably coupled to the dispenser body 16 and can be in communication with the cartridge receiving cavity 18. A cartridge 26 can be carried by the dispenser body in the cartridge receiving cavity. The cartridge can be positioned so as to be in communication with the actuatable piston.

The cartridge can carry an edible fluid, which can take a variety of forms. Non-limiting examples of such an edible fluid include sauces, juices, marinades, bastes, frostings, dessert toppings, condiments, creams, and the like. The edible fluid 14 can be injectable into a food product through the dispenser tips 22 as the actuatable piston 24 is actuated. Actuation of the piston causes a plunger 28 to compress the fluid within the cartridge 16, forcing the fluid into the base 20 and through and out of dispensing tips 22.

The technology thus provides a very easy-to-use system by which a variety of fluids can be applied to food products during meal preparation. Generally, a user manually causes the piston 24 to advance plunger 28 into the replaceable or cartridge 26. As the plunger advances into the cartridge (downward along the direction shown at 11 in FIGS. 1, 2 and 3), the fluid is compressed and forced out of the dispensing tips 22.

Actuation of the piston 24 can be achieved in a variety of manners. In one aspect, the user can simply apply force to an upper portion of the piston, causing plunger 28 to move further into the replaceable cartridge 26. In one embodiment, an actuation system can be utilized to make this process easier for the user. For example, in the aspect shown in FIG. 1, a moveable handle 30 is pinned (via pin 32, for example) to the dispenser body. The moveable handle is operably coupled to the actuatable piston 24 such that movement of the moveable handle results in movement of the actuatable piston. In the embodiment shown in FIG. 1, movement of the handle 30 along direction 13 results in the piston 24 moving in direction 11. Thus, a user can simply squeeze the handle 30 and thereby cause the piston to move further into the replaceable cartridge 26 to thereby force the fluid 14 through and out dispenser tips 22.

As shown in FIGS. 1 and 4, piston 24 can include a threaded or toothed section 34. This threaded section is engaged (indirectly in this example) by cross member 36. Cross member 36 is coupled to handle 30 such that movement of handle 30 results in movement of cross member 36. As best shown in FIG. 4, a toothed or threaded cog 38 can engage both the cross member and the piston. Thus, translational motion of the cross member (shown by directional indicator 31) results in rotational movement of the cog 38, which in turn translates to transverse directional movement (11 in FIG. 1) of the piston. The cog 38 can be held in position via a variety of structural components, such as shoulder braces 40 (two of which are shown in FIG. 4).

In this example, the injector 10 can include a cap 48 that can be removably fastened to the dispenser body 16. This cap can carry cog 38 that converts lateral movement of the moveable handle 30 into transverse lateral movement of the threaded piston 24. The cap also provides an easy manner by which the replaceable cartridge 26 can be removed from or installed within the body 16. The cap can be threadably engaged with the dispenser base 20 so as to be easily removed from the base to allow access to the cartridge receiving cavity 18.

This embodiment is but one example of the manner in which desired translational motion of the piston 24 can be achieved through the use of a handle 30 or similar structure. One of ordinary skill in the art having possession of this disclosure will readily appreciate other manners of achieving the same function.

The dispenser body can advantageously include a viewing port 70 formed in (or defined by) one or more walls of the dispenser. The viewing port can allow a user to view a label applied to the replaceable cartridge to verify the contents of the cartridge. In this manner, a user need not remove the cartridge from the modular injector to verify the contents thereof.

Turning more particularly now to FIGS. 2 and 3, one manner by which the various modular components of the system can be coupled one to another is shown. In this example, the replaceable or interchangeable cartridge 26 includes a series of external threads 50 which are adapted to mate with internal threads 52 formed in the dispenser body 16. Thus, the replaceable cartridge can be easily and quickly installed within (or removed from) the dispenser body. The dispenser body can similarly be easily installed within the dispenser base 20 by way of external threads 54 on the body 16 mating with internal threads 56 in the base 20. As a passageway 60 is formed in the base, a complete fluid path is created for the fluid 14 within the replaceable cartridge. It can thus be expelled from the cartridge, through the base 20, and through and out of dispenser tips 22.

As shown in FIG. 3, in one aspect of the present disclosure, the cartridge 26 can carry the edible fluid 14 beneath a moveable seal 68. The moveable seal can protect the edible fluid from contamination from external sources, and can prevent the fluid from being impelled through the top of the cartridge. The seal can also move within the cartridge during use. Thus, the seal continues to protect the edible fluid during and after use of the cartridge. The moveable seal can be formed from a variety of suitable materials, including polymers, foils and the like.

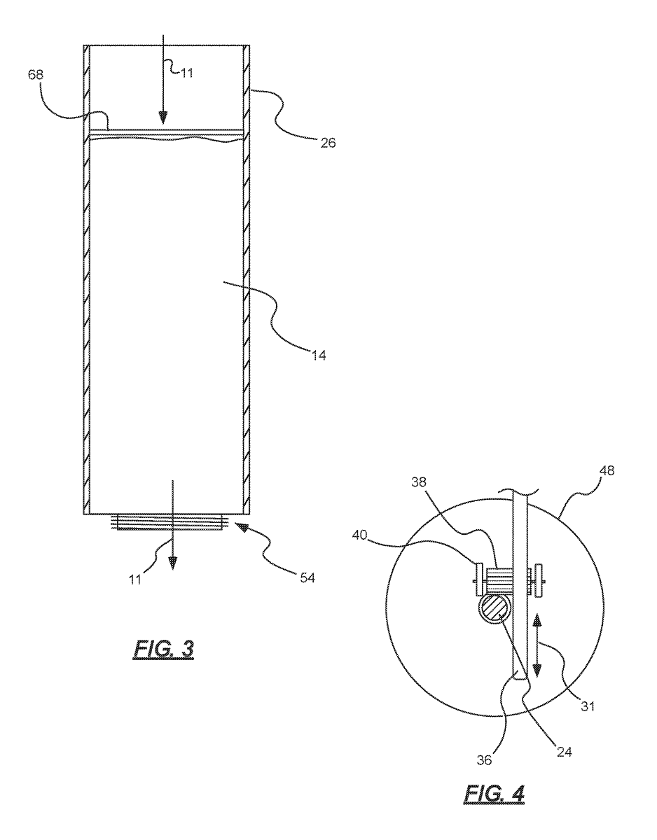

As discussed, the dispenser base 20 can be removably coupled to the dispenser body 16. This arrangement allows a user to very easily and quickly change the base and dispenser tips that are to be used with the modular device. In the example shown in FIGS. 1 and 5, the series of dispenser tips 22 include generally conic dispenser tips. These tips not only dispense the edible fluid 14, but are also capable of piercing the surface of a variety of food products (e.g., meat products) to allow the fluid to be injected under the surface of the food product.

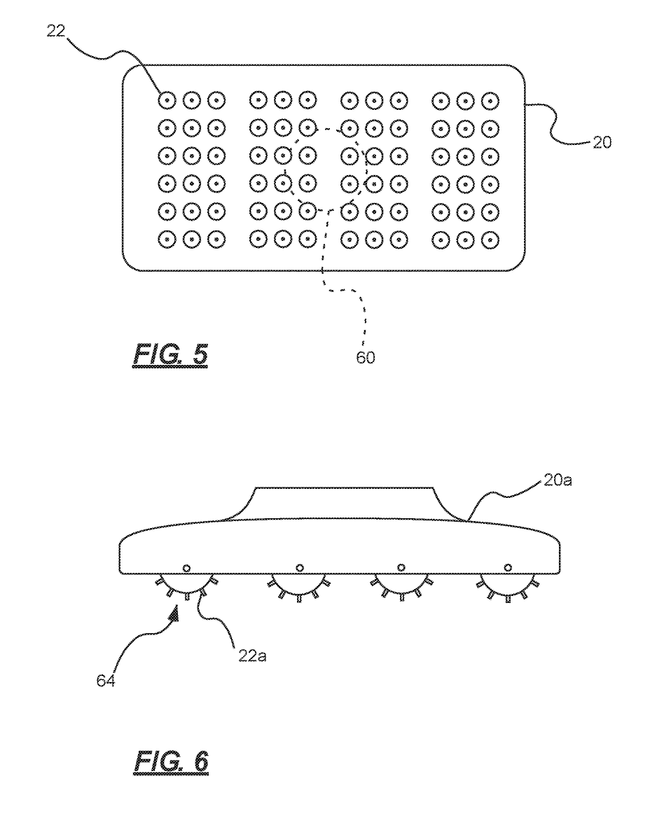

In another embodiment, shown in FIG. 6, the dispenser tips can be installed on rolling cylinders or spheres 64 that are in turn fluidly coupled to the replaceable cartridge 26. A variety of other configurations of dispenser tips can also be used. For example, a stationary meat injector can be used as well that has injectors or an an array of injectors, but which does not roll. For example, in the aspects illustrated in FIGS. 7A through 7C, base 22b is configured to receive a single dispensing tip 22b. This can be achieved through threaded connection 66. Dispenser tip 22b can be advantageously used in applications that require a wide orifice for dispensing the fluid. Suitable applications include, without limitation, frosting baked goods, applying a relatively viscous fluid to food products, etc. FIGS. 7B and 7C illustrate further exemplary tips 22c, 22d that can also be used in such applications. With more specificity and by way of example, cake decorating tips can be of various shapes to extrude viscous frosting lines or beads with various cross-sectional shapes, e.g., round, oval, triangle, square, star shape, etc. Alternatively, a basting tip applicator may include a sponge-like tip for defusing seasoning over the top of a turkey, for example.

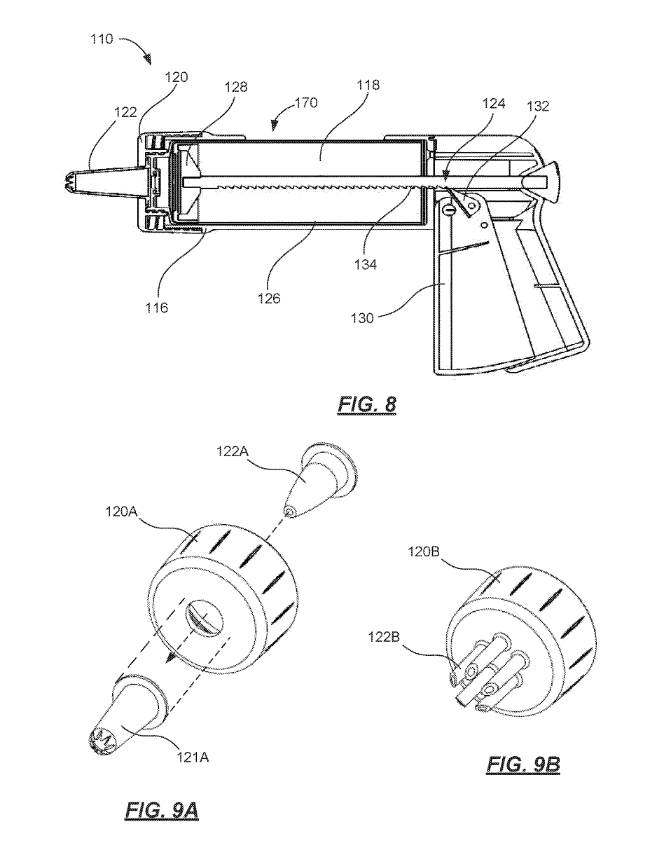

Turning now to FIG. 8, an injector 110 for introducing an edible fluid, such as shown at 14 in FIG. 3, into a food product is shown. The modular injector in FIG, 8 can include a dispenser body 116 that can define or have attached thereto a cartridge receiving cavity 118. A dispenser base 120 (or dispenser tip adapter) can be coupled to the dispenser body. In this instance, the dispenser base and the dispenser body are shown as being attached to one another by threads. The dispenser base can carry, or can have attached thereto, a dispenser tip 22 (only one dispenser tip shown in FIG. 8, but FIGS. 9A-9D show alternative dispenser tips). The dispenser tip is adapted to be in fluid communication with the cartridge receiving cavity. As mentioned before, the dispenser base and the dispenser tip can be a single integrated unit, or be part of a modular assembly. The injector can also include an actuatable piston 124 that can be operably coupled to the dispenser body and can be in communication with the cartridge receiving cavity. A cartridge 126 can be carried by the dispenser body in the cartridge receiving cavity. The cartridge can thus be positioned so as to be in communication with the actuatable piston. As shown in FIG. 8, the actuatable piston is shown all the way forward, and thus in this FIG., the edible fluid contained in the cartridge has been pushed through the dispenser tip. Essentially, actuation of the piston causes a plunger 128 to compress the fluid within the cartridge, forcing the fluid through and out of the dispensing tip. To remove the cartridge and replace it, the actuatable piston can be withdrawn and the cartridge removed and replaced. Removal of the cartridge can be in any manner designed, such as through a front opening when the dispenser base is removed, through a side opening provided it is large enough to receive the cartridge, or by any other method that allows for inserting and removing cartridges. Again, the dispenser body can advantageously include a viewing port 170 formed in (or defined by) one or more walls of the dispenser. The viewing port can allow a user to view a label applied to the replaceable cartridge to verify the contents of the cartridge. In this manner, a user need not remove the cartridge from the modular injector to verify the contents thereof.

As mentioned previously, actuation of the piston 124 can be achieved in a variety of ways. As shown in FIG. 8, the injector 110 has a gun configuration with a squeeze handle or trigger 130 associated with a pivoting advancement mechanism 132 that engages with a toothed section 134 of the piston. The pivoting advancement mechanism both prevents retreat of the piston when the trigger at rest, and also advances the piston when the trigger is squeezed. The piston can be withdrawn by moving the pivoting advancement mechanism out of the way so that it does not catch on the toothed section.

FIGS. 9A to 9D show perspective view of various dispenser tips and dispenser base configurations. These can be mixed and matched as desired, or can be mixed and matched with other examples described herein. FIG. 9A is a perspective view of a modular dispensing base 120A and two different dispensing tips 121A and 122A (to be used in the alternative) that are suitable for application of frosting in accordance with an embodiment of the present disclosure. In this example, one of the frosting tips is inserted or sealed through opening 123, and the dispensing base is then attached to the dispenser body (shown in FIG. 8). One is shown on the front to illustrate relative location and one is shown from the back to show how insertion into the dispenser base would occur. FIG. 9B is a perspective view of an integrated dispensing base 120B with dispensing tip injectors 122B that are suitable for injection of edible fluid into a meat product in accordance with an embodiment of the present disclosure. The tip injectors could be longer or shorter, or there could be fewer or more injectors. FIG. 9C is a perspective view of a modular dispensing base 120C and a dispensing tip basting brush 122C suitable for basting a food product with an edible fluid in accordance with an embodiment of the present disclosure. Notably, the dispensing base includes openings 123C which can be in fluid communication with openings 125C on the dispensing tip basting brush. Thus, the edible fluid can pass through the various openings and become dispensed onto the basting brush. FIG. 9D is a perspective view of a modular dispensing base 120D and a dispensing tip roller 122D suitable for tenderizing a meat product with an edible fluid in accordance with an embodiment of the present disclosure. In this example, openings 123D are present on the dispensing base for the edible fluid to pass therethrough and become dispensed onto the dispensing tip roller.

It is to be understood that the above-referenced arrangements are illustrative of the application for the principles of the present disclosure. Numerous modifications and alternative arrangements can be devised without departing from the spirit and scope of the present disclosure. While the present technology has been shown in the drawings and described above in connection with the exemplary embodiments(s) of the present disclosure. It will be apparent to those of ordinary skill in the art that numerous modifications can be made without departing from the principles and concepts of the present disclosure as set forth in the examples.

what is claimed is:

1. A modular device for introducing an edible fluid to a food product, comprising:
a dispenser body having a cartridge receiving cavity associated therewith;
a dispenser base, coupleable to the dispenser body;
a dispenser tip, coupleable to or integrated with the dispenser base and being in fluid communication with the cartridge receiving cavity when attached to the dispenser body through the dispenser base;
an actuatable piston, operably coupled to the dispenser body in communication with the cartridge receiving cavity;
an insertable and removable cartridge, carriable by the dispenser body in the cartridge receiving cavity, the cartridge being positionable so as to be in communication with the actuatable piston; and
an edible fluid, carried by the cartridge, the edible fluid being deliverable to a food product through the dispenser tip when in place as the actuatable piston is actuated to cause the edible fluid to be expelled from the cartridge through the dispenser tip.

2. The modular device of claim 1, further comprising a moveable handle associated with the dispenser body and being operably coupled to the actuatable piston, wherein movement of the moveable handle results in actuation of the actuatable piston.

3. The modular device of claim 2, wherein the piston includes a threaded or notched piston shaft operably engaged with the moveable handle.

4. The modular device of claim 1, wherein the disperser base and the dispenser tip are a single integrated unit.

5. The modular device of claim 1, wherein the dispenser base is separate than the dispenser tip, and the dispenser tip is coupleable with the dispenser base.

6. The modular device of claim 1, wherein the dispenser tip further includes a series of dispenser tips, wherein i) each of the dispenser tips is integrated with a dispenser base that is coupleable to the dispenser body, ii) each of the dispenser tips is coupleable to one or more dispenser base that is coupleable to the dispenser body, or iii) a combination of i) and ii).

7. The modular device of claim 6, wherein the series of dispenser tips include at least one tip adapted for tenderizing or injecting fluid into a meat and at least one tip is adapted for application of frosting.

8. The modular device of claim 6, wherein the series of dispenser tips comprise a series of conic dispenser tips.

9. The modular device of claim 6, wherein the series of dispenser tips comprise a series of meat tenderizer and fluid injection tips.

10. The modular device of claim 1, wherein the dispenser tip includes multiple tips arranged on a rolling core.

11. The modular device of claim 1, wherein the dispenser tip is adapted for meat basting or injection.

12. The modular device of claim 1, wherein the dispenser tip is adapted for frosting application.

13. The modular device of claim 1, wherein the cartridge carries an edible fluid beneath a moveable seal, and wherein actuation of the actuatable piston results in movement of the moveable seal to thereby impel movement of the edible fluid from the cartridge.

14. The modular device of claim 1, wherein the dispenser body includes a viewing port formed therein, the viewing port allowing a user to view a label attached to the replaceable cartridge disposed in the cartridge receiving cavity.

15. The modular device of claim 1, wherein the food product comprises a meat product, and the edible fluid is suitable for injection into the meat product, and the dispenser tip includes an injector.

16. The modular device of claim 1, wherein the food product comprises a meat product, and the edible fluid is suitable for application onto the meat product, and the dispenser tip is adapted for basting.

17. The modular device of claim 1, wherein the food product is a dessert, and the edible fluid is suitable for application as dessert topping or frosting, and the dispenser tip includes a frosting applicator.

18. The modular device of claim 1, further comprising a cap removably coupled to the dispenser body, the cap being removable to allow the cartridge to be installed within or withdrawn from the cartridge receiving cavity.

19. A method of applying an edible fluid to a food product utilizing a modular device that includes a series of dispenser tips adapted for interchangeability and a dispenser body adapted for receiving insertable and removable cartridges, comprising:
selecting a dispenser tip suitable for delivering an edible fluid to the food product;
positioning a cartridge within a dispenser body, the cartridge carrying the edible fluid;
attaching the dispenser tip to the dispenser body and in fluid communication with the edible fluid within the cartridge; and
manually actuating a piston associated with the dispenser body to impel the edible fluid from the cartridge through the dispensing tip and into or onto the food product.

20. The method of claim 19, further comprising removing the cartridge and replacing it with a second cartridge.

21. The method of claim 19, wherein actuating the piston causes a moveable seal within the cartridge to impel movement of the edible fluid from the cartridge.

22. The method of claim 19, wherein the dispenser tip is adapted for injection of the edible fluid into a meat.

23. The method of claim 19, wherein the dispenser tip is adapted for basting a meat with the edible fluid.

24. The method of claim 19, wherein the dispenser tip is adapted for tenderizing a meat surface in the present of the edible fluid.

25. The method of claim 19, wherein the dispenser tip is adapted for frosting a dessert with the edible fluid.

26. The method of claim 19, wherein the dispenser tip is adapted for dispensing a condiment.
